(19) United States
(12) Patent Application Publication
(10) Pub. No.: US 2026/0016053 A1
(43) Pub. Date: Jan. 15, 2026

(54) ELECTROMAGNETICALLY SHIFTABLE POSITIVE ENGAGEMENT CLUTCH AND METHOD FOR POSITION DETERMINATION

(71) Applicant: Hoerbiger Antriebstechnik Holding GmbH, Schongau (DE)

(72) Inventors: Juergen BINDER, Schongau (DE); Peter ECHTLER, Schongau (DE); Andreas DEMPFLE, Schongau (DE); Werner FUERGUTH, Schongau (DE); Wolfgang VOELK, Schongau (DE); Sebastian KUCHAREK, Schongau (DE); Marco LAUTENSACH, Schongau (DE)

(21) Appl. No.: 19/267,139

(22) Filed: Jul. 11, 2025

(30) Foreign Application Priority Data
Jul. 11, 2024 (DE) 102024119790.0

(51) Int. Cl. F16D 27/118; G01D 5/14

(52) U.S. Cl. CPC F16D 27/118; G01D 5/145; F16D 2300/18; G01D 2205/18

(57) ABSTRACT

An electromagnetically shiftable positive engagement clutch has a movable part arranged on a shaft for joint rotation therewith and is linearly displaceable along the shaft between a clutch engagement position and a clutch disengagement position. The positive engagement clutch includes at least one fixed part which is aligned coaxially with the shaft, and a stator having at least one energizable drive coil for adjustment of the movable part along the shaft, wherein in the clutch engagement position there is a positive engagement between the movable part and the fixed part and thus a rotary connection between the shaft and the fixed part.

### CROSS REFERENCE TO RELATED APPLICATION

This application claims priority from German Patent Application Serial No. 10 2024 119 790.0, Filed Jul. 11, 2024, the contents of which are incorporated herein by reference.

### TECHNICAL FIELD

The disclosure relates to an electromagnetically shiftable positive engagement clutch. Furthermore, the disclosure relates to a method of determining a position of an axially movable part of an electromagnetically shiftable positive engagement clutch.

### BACKGROUND OF THE INVENTION

If a torque is to be temporarily transmitted from one shaft to another, coaxially aligned shaft without these two shafts being connected permanently, clutches are typically employed. A distinction is made here between frictionally engaging and positively engaging clutches. The present disclosure relates to positively engaging clutches, which are referred to herein as positive engagement clutches. Positive engagement clutches include tooth clutches and dog clutches, for example, which engage in a form-fitting manner to transmit torque.

For positive engagement clutches, displaceable shifting sleeves are often used. These include one or also a plurality of different toothings that engage with mating toothings in a form-fitting manner so that a positive engagement, i.e. an engagement in a form-fitting manner, is produced that allows a torque to be transmitted from a first shaft to a second shaft.

Disclosed in the prior art are electromagnetic clutches in which the adjustment of the shifting sleeve takes place by means of a drive coil that exerts a magnetic force on the shifting sleeve. In clutches of this type, the shifting sleeve can be moved in one direction starting from a disengagement position in order to move the shifting sleeve into engagement with a clutch body. This is referred to as an overrunning clutch.

Furthermore, two-sided clutches are known, in which the shifting sleeve can be moved in opposite directions starting from a disengagement position in order to move the shifting sleeve into engagement with different, axially spaced apart clutch bodies.

In particular in electromagnetically shiftable positive engagement clutches, a controller is provided that controls a displacement of the shifting sleeve by means of control commands. For a best possible clutch operation process, it is necessary here to know the current position of the shifting sleeve, which is also referred to as the engagement position. The reason for this is that for each control command transmitted to the electromagnetically shiftable positive engagement clutch, the current state of engagement should first be analyzed, so that the controller should be able to interrogate the position of the shifting sleeve at any time.

In the prior art, the shifting state or the engagement position of the shifting sleeve is determined using indirect measurements, for example by the current status of the stator or the speed of the shafts to be connected.

It is likewise known to use Hall sensors for position detection, which determine the position based on the change in the magnetic field. The sensor devices required for this, however, have a complex structure and, accordingly, require a comparatively large amount of installation space.

It is also possible to employ switches in order to determine the end position of the shifting sleeve, that is, an engagement position or disengagement position of the shifting sleeve. The switch is actuated here by a dedicated actuating part when the shifting sleeve is in the engagement position.

As an alternative to a switch, a travel measuring system may also be used, which is likewise actuated through an additional component.

The methods known in the prior art for detecting the position of the shifting sleeve thus distinguish themselves in that indirect measurements are involved, which require an additional component to be scanned or actuated. A direct and precise determination at the actual clutch engagement position is therefore not possible; rather, additional components are always required.

In addition, the position of the shifting sleeve is usually detected in the axial direction, so that the installation space required for the positive engagement clutch increases.

Furthermore, the additionally required components and the installation space required increase the manufacturing costs of the positive engagement clutch.

Besides, these measuring techniques often require precise calibration of the sensor in relation to the point of measurement, which is usually very elaborate and therefore cost-intensive.

It is therefore an object of the disclosure to provide an electromagnetically shiftable positive engagement clutch in which the engagement position is determined by means of a direct measurement and very rapidly and accurately. It is also an object to keep the required installation space and the number of components required as low as possible. Furthermore, it is an object to provide a method of determining the engagement position, which determines positions as precisely as possible.

### SUMMARY OF THE INVENTION

The disclosure provides an electromagnetically shiftable positive engagement clutch, including an axially movable, driven part which is arranged on a shaft for joint rotation therewith and is linearly displaceable along the shaft between a clutch engagement position and a clutch disengagement position. Furthermore, the positive engagement clutch includes at least one axially fixed part to be driven, which is aligned coaxially with the shaft, and a stator having at least one energizable drive coil for adjustment of the movable part along the shaft, wherein in the clutch engagement position there is a positive engagement between the movable part and the fixed part and thus a rotary connection between the shaft and the fixed part. Moreover, the positive engagement clutch includes a stationary sensor device which is arranged adjacent to the movable part and which includes at least one Hall sensor and at least one magnet that is arranged next to and permanently stationary relative to the at least one Hall sensor. The sensor device here is arranged in an axial or radial direction so as to be spaced apart from the movable part by a gap, and the Hall sensor is configured such that it can detect an axial movement of the movable part through a change in a field line angle of a magnetic field generated by the magnet.

In other words, at least one Hall sensor is arranged in a magnetic field of a magnet in the positive engagement clutch such that the Hall sensor can sense a change in the field line angle due to the magnetic field change resulting from the axial movement of the movable part, and a controller can determine the engagement position of the movable part based on this data. Since this involves a direct measurement, no additional components are required, resulting in the manufacturing costs being reduced. In addition, Hall sensors used for field line angle measurements are commonly used sensors that are available at low cost, respond quickly and require little space. The sensor device with the Hall sensor thus allows the exact position of the movable part to be detected without or independently of the coil current.

Therefore, the change in the field line angles of the magnetic field, which can be measured based on the Hall effect, is made use of to determine the position of the movable part. This means that a change in an electrical voltage is measured in a current-carrying conductor that is located in a magnetic field. The change in the magnetic field upon an axial movement of the movable part results in exactly such a voltage change, based on which the change in the field line angles can be determined. Since the Hall sensor is magnetically enclosed by at least one magnet, the influence of the magnetic field of the drive coil, which may lead to uncontrolled changes in the Hall effect, can be prevented or reduced. In addition, this arrangement allows a permanent magnet fastened on the movable part to be dispensed with. This can significantly reduce production costs, since a ring-shaped permanent magnet suitable for the movable part is a custom-made product, which usually markedly increases production costs. Additionally, the sensor device can provide more accurate results in terms of determining the position of the movable part, since the field line angles can be determined with an accuracy of up to a few millidegrees (m°).

The movable part may be a shifting sleeve or an armature, while the fixed part may be in the form of a clutch body. Here, the armature and/or the shifting sleeve are for example made of a ferromagnetic metal.

For example, the Hall sensor comprises an evaluation unit that is configured to determine the field line angle of the magnetic field generated by the magnet. Furthermore, the evaluation unit may be configured to pass the field line angle determined on to a controller of the electromagnetically shiftable positive engagement clutch. Accordingly, an evaluation unit, for example in the form of a microprocessor, is thus integrated in the sensor device, for example even directly in the Hall sensor. This allows the Hall sensor to output the field line angle directly, without the field line angle first having to be determined by the controller of the positive engagement clutch.

It is therefore preferred to install Hall sensors having an integrated evaluation unit. Alternatively, however, a conventional Hall sensor may also be used, which is connected to a microprocessor and/or the controller, so that the field line angle is calculated by the microprocessor and/or the controller. In the case in which the Hall sensor is connected to a microprocessor, the latter is for example also embedded in the sensor device, so that a unit made up of the Hall sensor, microprocessor and for example also the controller can be installed.

According to one embodiment, the Hall sensor comprises two measuring points. Providing two measuring points allows a more accurate result of the field line angle to be output, so that the position of the movable part calculated therefrom also has a higher accuracy.

According to a further embodiment, the sensor device comprises two magnets, the Hall sensor being arranged between the two magnets. By providing two magnets, a stronger magnetic field can be generated in which the Hall sensor is arranged. Since the magnetic field of two magnets is stronger than that of one magnet, the change in the field line angle is also greater with two magnets, which allows a more accurate measuring result to be provided here as well. In addition, by providing two magnets, the Hall sensor is better shielded from the magnetic field of the stator and thus the signal provided by the Hall sensor is amplified, so that an overall higher resolution can be achieved.

For example, the two magnets each have a magnetic axis and are arranged obliquely with respect to a central axis of the Hall sensor. The magnetic axes are directed toward each other and are arranged at an acute angle relative to the central axis. For example, this is an acute angle of less than 45 degrees. The unsymmetrical orientation of the magnetic axes results in the best possible magnetic field orientation and, accordingly, to a strong magnetic field in order to determine the field line angles and, in particular, the change in the field line angles as accurately as possible.

According to a preferred embodiment, the magnets are permanent magnets or electromagnets. Accordingly, these are commonly used magnets that are easily available and therefore cost-effective.

According to a further embodiment, the sensor device comprises at least two Hall sensors, wherein for example each of the Hall sensors is assigned at least one magnet that is adjacent to the associated Hall sensor. In this way, additional measuring points can be provided, which improve the measuring accuracy and/or the measuring result and accordingly provide a higher resolution for determining the position of the movable part.

For example, the sensor device is received in a sensor housing that is mounted to a stator housing. In this way, installation space problems can be avoided since the sensor does not need to be disposed between the movable part and the fixed part or directly next to or above the fixed part.

The sensor housing is for example made from a plastic material and includes a holder that can be used to fasten the sensor housing to the stator housing. To this end, the holder may, for example, be screwed, glued, welded or riveted to the stator housing.

According to a preferred embodiment, at least two sensor devices are provided, the at least two sensor devices being arranged offset from each other in the circumferential direction. This allows an unequal displacement of the movable part, for example due to a tilting of the movable part, to be detected at an early stage. Accordingly, the movable part can also be controlled such that the tilting movement is neutralized, or a quick disengagement and re-engagement process can be briefly performed.

According to a further embodiment, each magnet has a magnetically soft material associated with it, the magnetically soft material being arranged next to the magnet on the side opposite from the Hall sensor or under the magnet on the side thereof facing the movable part. The magnetically soft material serves to guide the magnetic flux and can therefore amplify the signal of the Hall sensor and prevent undesirable changes in the Hall effect due to the magnetic field generated by the stator. Therefore, the magnetically soft material provides an additional shielding from the magnetic field of the drive coil and amplifies the magnetic field of the magnet arranged in the sensor device, which results in as great a change in the field line angles as possible.

The object is also achieved in accordance with the disclosure by a method of determining a position of a movable part of an electromagnetically shiftable positive engagement clutch as has been described above. The method comprises the steps of:
detecting a Hall voltage by means of a Hall sensor;
calculating a field line angle by means of an evaluation unit integrated in the Hall sensor;
passing the field line angle on to a controller of the electromagnetically shiftable positive engagement clutch; and
assigning, by means of the controller, a unique position of the movable part based on the calculated field line angle.

Accordingly, the fundamental idea is that the position determination is based on the change in the field line angles, which is passed on to the controller by the sensor device, thus allowing as accurate a position of the movable part as possible to be determined.

As already discussed previously, the axial movement of the movable part causes a change in the magnetic field. This also causes the magnetic flux through the Hall sensor to change, so that a Hall voltage is detected. Based on the Hall voltage, the evaluation unit, which is realized, e.g., by a microprocessor, can determine the field line angle and pass it on to the controller.

Optionally, the position of the movable part is determined by a plurality of Hall sensors, in particular Hall sensors that are offset from each other along the circumference of a stator. The positions determined by the various Hall sensors are compared with each other by the controller of the positive engagement clutch so that a possible incorrect position of the movable part can be rectified as quickly as possible, for example by an appropriate control of the positive engagement clutch or a brief disengagement and re-engagement.

According to a further development, the field line angle is determined for each position of the movable part of the electromagnetically shiftable positive engagement clutch. As a result, the current position of the movable part is stored for the controller of the positive engagement clutch at all times and any and all clutch operation processes can be carried out in an optimized manner and without delay.

### BRIEF DESCRIPTION OF THE DRAWINGS

FIG. 1 shows a sectional representation of an electromagnetically shiftable positive engagement clutch according to the disclosure, with a shifting sleeve in the disengagement position;

FIG. 2 shows a perspective partial view of the positive engagement clutch shown in FIG. 1 in the region of the attachment of a sensor device;

FIG. 3 shows a detailed perspective view of the sensor device shown in FIG. 2;

FIG. 4 shows a schematic sectional view of the sensor device shown in FIGS. 2 and 3;

FIG. 5 shows a further detailed perspective view of the sensor device shown in FIGS. 2 to 4;

FIGS. 6A to 6C show a schematic illustration of a clutch operation process, with FIG. 6A showing a clutch disengagement position, FIG. 6B showing an intermediate position and FIG. 6C showing a clutch engagement position;

FIGS. 7A and 7B show a schematic illustration of the magnetic field in different engagement positions, with FIG. 7A showing the magnetic field of the clutch disengagement position shown in FIG. 6A and FIG. 7B showing the magnetic field of the clutch engagement position shown in FIG. 6C;

FIG. 8 shows a detailed schematic view of the magnetic field shown in FIG. 7A; and

FIG. 9 shows a second configuration of the sensor device that can be employed in the disclosure.

### DETAILED DESCRIPTION OF THE INVENTION

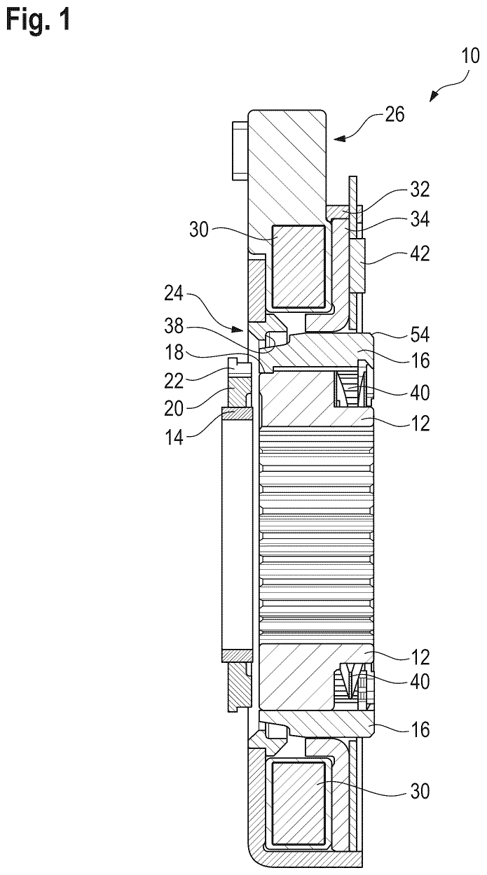

FIG. 1 shows an electromagnetically shiftable positive engagement clutch 10, which has the function of coupling a first shaft 12 and a second shaft 14 that is coaxially aligned with the first shaft 12 to each other by opening and closing.

The positive engagement clutch 10 shown in FIG. 1 is an electromagnetic tooth clutch having teeth that project radially inward and radially outward and engage with one another.

The electromagnetically shiftable positive engagement clutch 10 may, however, also be any other type of toothed clutch. It is only important that the connection is established by a positive engagement.

The electromagnetically shiftable positive engagement clutch 10 comprises an axially movable, driven part 15, which in this exemplary embodiment of the positive engagement clutch 10 is a shifting sleeve 16, which includes a first toothing 18 laterally along the circumference.

Furthermore, the shifting sleeve 16 is arranged on a first shaft 12 for joint rotation therewith and is axially adjustable along it between a clutch engagement position and a clutch disengagement position along a toothing 19 coupling the shaft 12 and the shifting sleeve 16. FIG. 1 shows the shifting sleeve 16 in the disengagement position.

Associated with the second shaft 14 is an axially fixed part 21 to be driven, which in this exemplary embodiment of the positive engagement clutch 10 is a singular clutch body 20, which is coupled to the second shaft 14 for joint rotation with it.

The clutch body 20 includes a second toothing 22, which is arranged along the outer circumference of the clutch body 20. Further, the clutch body 20 is aligned coaxially with the first shaft 12.

It is also conceivable, however, that the clutch body 20 forms part of the second shaft 14 and is formed integrally therewith.

The first toothing 18 and the second toothing 22 together form a clutch tooth system 24 and serve to form a positive engagement between the shifting sleeve 16 and the clutch body 20 in the engagement position of the shifting sleeve 16.

The clutch tooth system 24 formed of the first and second toothings 18, 22 may have undercuts at least on the teeth of the first toothing 18 and/or on the teeth of the second toothing 22, the undercuts being configured such that when a shifting sleeve 16 is in the clutch engagement position and a torque is applied to the positive engagement clutch 10, an additional displacement of the shifting sleeve 16 toward the clutch body 20 takes place because the circumferential force is converted into an axial displacement force. This can be achieved, for example, by undercuts that widen in a wedge shape, so that a wedge effect is produced in the direction of the clutch engagement position when a torque is transmitted.

Moreover, a stator 26 is provided which comprises a stator housing 28 and a drive coil 30 which is at least partly received in the stator housing 28.

The stator housing 28 comprises a housing pot 32, which extends along the circumference of the drive coil 30 and along a face side of the drive coil 30.

Furthermore, the stator housing 28 includes a housing ring 34 which extends along the circumference of the drive coil 30 and additionally extends on the face side of the drive coil 30 opposite to the housing pot 32.

The drive coil 30 is used for linear adjustment of the shifting sleeve 16 along the first shaft 12 toward the engagement position up to the clutch body 20.

Alternatively, it is also conceivable that the drive coil 30 is used for adjustment of the shifting sleeve 16 along the first shaft 12 toward the disengagement position of the shifting sleeve 16.

Adjustment of the shifting sleeve 16 is effected using a magnetic force that is exerted on the shifting sleeve 16 when the drive coil 30 is energized.

In order to displace the shifting sleeve 16 back to the disengagement position, an elastic spring unit 40 is provided, by means of which the shifting sleeve 16 is coupled to the first shaft 12 so as to be displaceable in the axial direction.

The elastic spring unit 40 is arranged here between the shifting sleeve 16 and the first shaft 12 in such a way that a relative displacement of the shifting sleeve 16 in the axial direction toward the clutch engagement position results in a compression of the elastic spring unit 40. This generates a restoring force which the first elastic spring unit 40 exerts on the shifting sleeve 16.

The restoring force acts in opposition to the magnetic force of the drive coil 30.

The elastic spring unit 40 is arranged within a recess in the shaft 12 and presses axially against a wall on the shaft 12, on the one hand, and against a disk 41 fastened to the shifting sleeve 16, on the other hand.

Accordingly, the elastic spring unit 40 is accommodated in a space which is bounded radially on the inside by the first shaft 12 and radially on the outside by the shifting sleeve 16.

The spring unit 40 may for example be a wave spring or a wave spring assembly.

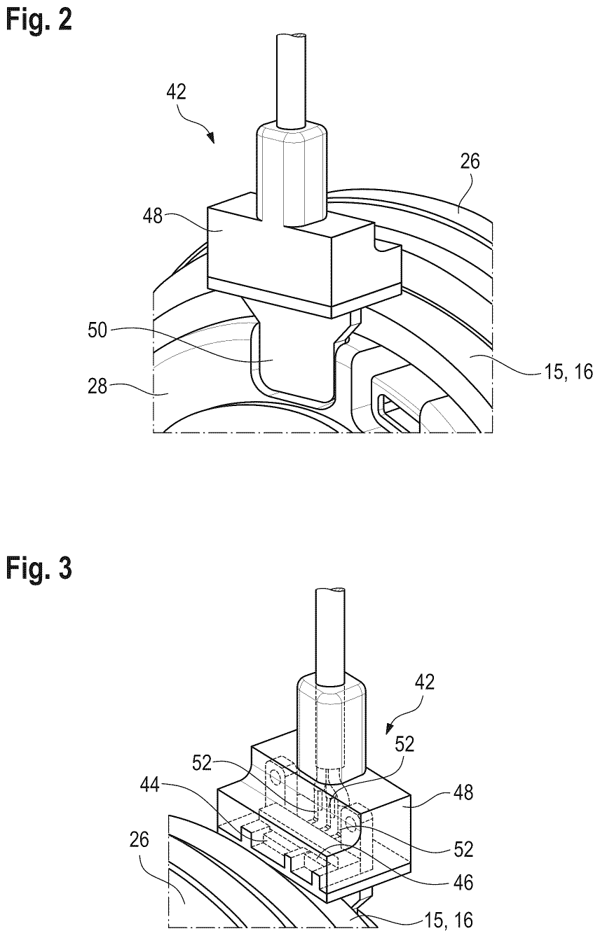

As can be seen in particular in the detailed view in FIGS. 2 and 3, the positive engagement clutch 10 in the first embodiment shown here further comprises a sensor device 42.

As can be seen in particular in FIGS. 3 to 5, the sensor device 42 comprises at least one Hall sensor 44 and a stationary magnet 46 arranged laterally next to the Hall sensor 44.

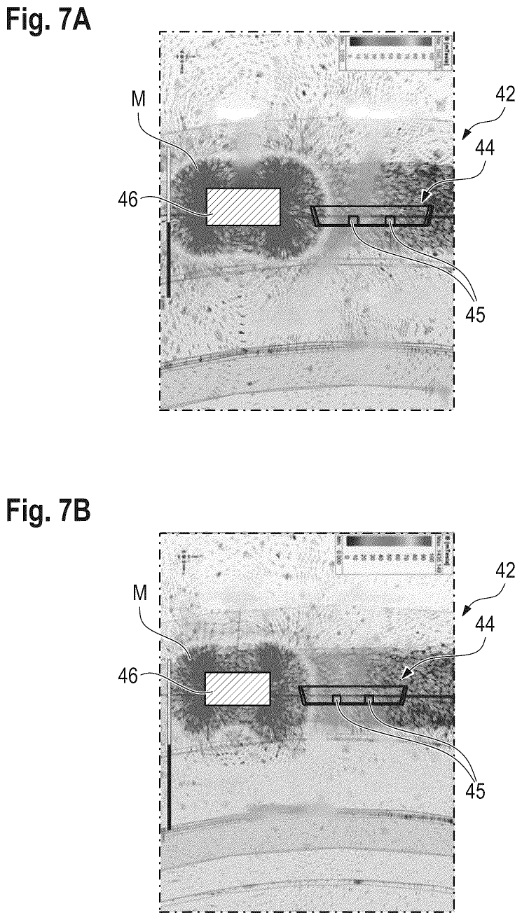

For example, the Hall sensor 44 has two measuring points 45 (see FIG. 7A) in order to ensure as accurate a position determination as possible.

The magnet is a permanent magnet or an electromagnet that is used to provide a stable magnetic field M for the Hall sensor 44. For this purpose, the magnet 46 is arranged to be permanently stationary next to the Hall sensor 44.

In order to ensure as strong a magnetic field M as possible and a best possible arrangement of the Hall sensor 44 in the magnetic field M, the magnet 46 is for example arranged at an angle to a central axis A of the Hall sensor 44.

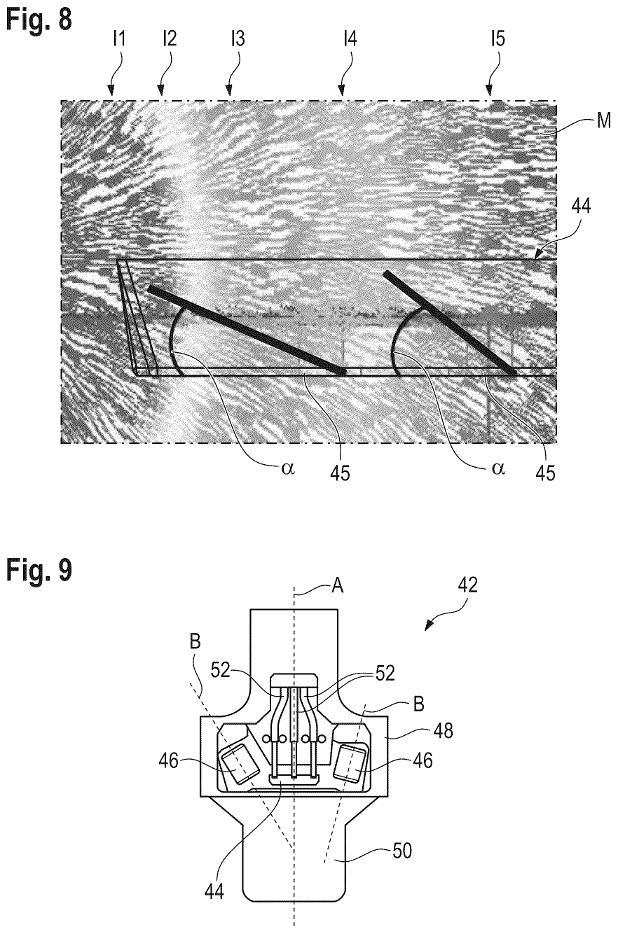

It can be seen in particular in FIG. 8 that the intensity 11, 12, 13, 14, 15 of the magnetic field M decreases as a distance from the magnet 46 increases.

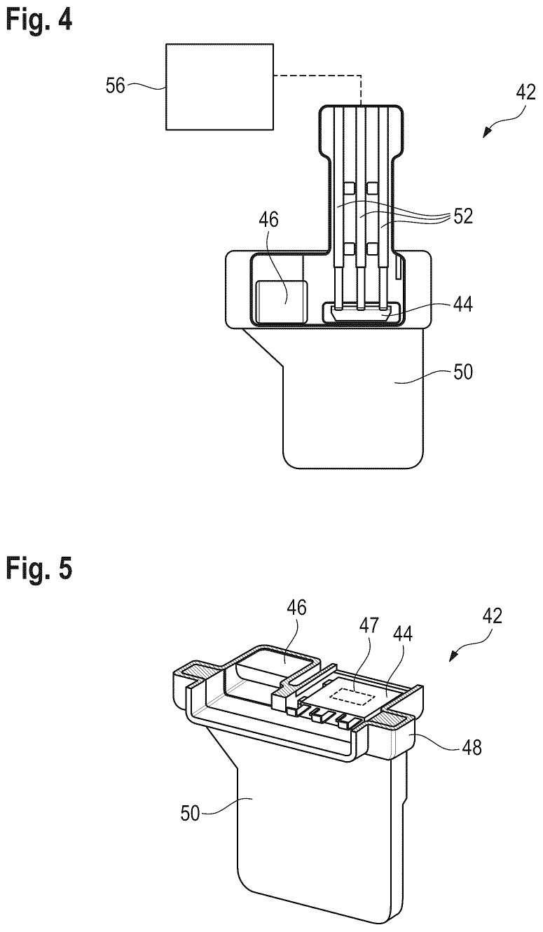

As can be clearly seen especially in FIG. 4, the Hall sensor 44 is connected to a controller 56 of the positive engagement clutch 10 by means of three lines 52.

An evaluation unit 47 is integrated in the Hall sensor 44. The evaluation unit 47 may be a microprocessor, for example.

The sensor device 42 is fastened laterally to the stator housing 28, which can be seen in particular in FIG. 2.

The sensor housing 48 may be fastened to the stator housing 28 by means of a holder 50 and/or fastening means such as screws, for example. Alternatively, the sensor housing 48 may also be glued or riveted to the stator housing 28.

In order that the engagement position of the shifting sleeve 16 can be determined, the sensor device 42 is fastened to the stator housing 28 in a radial or axial direction so as to be spaced apart from the shifting sleeve 16 by a gap.

An axial movement of the shifting sleeve 16 influences the magnetic field M of the magnet 46, so that the field line angles of the magnetic field M will change. The change in the field line angles is detected by the Hall sensor 44 by the change in the magnetic field M, and thus in the magnetic flux.

The function and operation of the positive engagement clutch 10 and the determination of the engagement position of the shifting sleeve 16 by means of the sensor device 42 will now be described below.

The initial state here is constituted by the disengagement position of the shifting sleeve 16, as shown in FIGS. 1, 6A and 8.

There is no positive engagement here between the first toothing 18 of the shifting sleeve 16 and the second toothing 22 of the clutch body 20.

In this disengaged and open state, the shifting sleeve 16 is held by the elastic spring unit 40 as long as no external forces at all act on the shifting sleeve 16 the amount of which exceeds the spring force of the spring unit 40.

This is also referred to as a positive engagement clutch 10 that is “normally open”.

As long as the shifting sleeve 16 is in the disengagement position, the magnetic field M does not change and a constant field line angle α is detected by the Hall sensor 44 of the sensor device 42.

Apart from the change in the field line angle α, the change in the magnetic field M also results in a change in the magnetic flux strength, that is, the intensity, as a result of which a Hall voltage is detected by the Hall sensor 44. Based on the Hall voltage, the evaluation unit 47 can determine the field angle α.

Although no change in the magnetic field M occurs while the shifting sleeve 16 is in the disengagement position, the Hall sensor 44 is nonetheless in a magnetic flux that causes a Hall voltage, so that the field line angle α can be determined even without an axial displacement, that is, regardless of whether the shifting sleeve 16 moves.

When the shifting sleeve 16 is to be displaced from the disengagement position toward the clutch body 20, a sufficient voltage first has to be applied to the drive coil 30.

Energizing the drive coil 30 is performed here by means of a controller 56, which is responsible for any clutch operation processes and which also processes the signals of the sensor device 42 (see FIG. 4).

Accordingly, the controller 56 is connected both to the drive coil 30 and to the sensor device 42, with the controller 56 and the sensor device 42 being connected to each other at least in terms of signaling.

Connecting the controller 56 to the sensor device 42 is for example performed by means of cables, lines 52 and/or plugs.

Energizing the drive coil 30 provides for a magnetic flux which causes a magnetic force to act on the shifting sleeve 16 in the direction of the clutch body 20.

When the amount of the magnetic force exceeds the amount of the spring force acting on the shifting sleeve 16 through the spring unit 40, a movement of the shifting sleeve 16 toward the clutch body 20 will occur.

The displacement of the shifting sleeve 16 results in that the magnetic field M of the magnet 46 changes, which also results in a change in the field line angles with respect to the Hall sensor 44.

The variation in the magnetic field M results in a change in the magnetic flux and thus in the Hall voltage detected by the Hall sensor 44, based on which the control and evaluation unit 47 can infer the field line angle α.

The evaluation unit 47 passes the field line angle α determined to the controller 56 again, which can allocate a unique position to the shifting sleeve 16 based on the field line angle α.

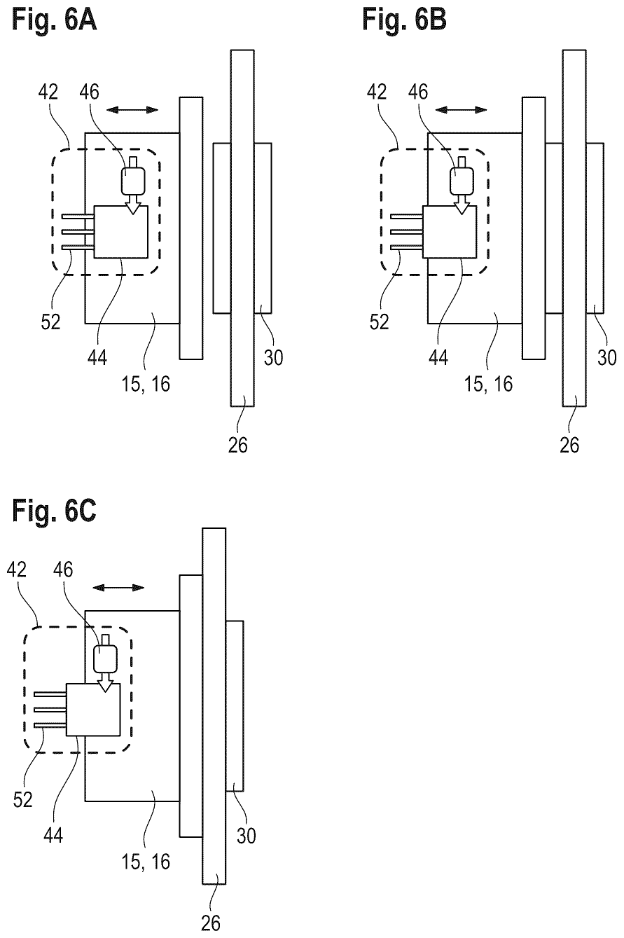

Thus, after the engagement position shown in FIG. 6B, the shifting sleeve 16 is finally in the clutch engagement position shown in FIGS. 6C and 7B. When the drive coil 30 is energized, a magnetic holding force acts on the shifting sleeve 16.

To ensure that each and every position of the shifting sleeve 16 between the clutch disengagement position and the clutch engagement position can be determined, the shifting sleeve 16 is for example made of a ferromagnetic material.

In the clutch engagement position, the first toothing 18 and the second toothing 22 engage with each other so that there is a positive engagement between the shifting sleeve 16 and the clutch body 20.

While the shifting sleeve 16 is in the clutch engagement position, the gap between the sensor device 42 and the shifting sleeve 16 does not change, so that no change in the Hall voltage can be detected by the Hall sensors 44.

Now when the shifting sleeve 16 is to be displaced back to its disengagement position, the magnetic force that is generated by the energizing of the drive coil 30 first has to be reduced or canceled.

If the amount of the magnetic force acting on the shifting sleeve 16 is below the amount of the restoring force caused by the elastic spring unit 40 acting on the shifting sleeve 16, this results in a displacement of the shifting sleeve 16 from the clutch engagement position back to the clutch disengagement position.

In this state, the shifting sleeve 16 is held by the spring force of the elastic spring unit 40.

When the shifting sleeve 16 is displaced from the clutch engagement position to the clutch disengagement position, the magnetic field M changes again due to the axial movement of the shifting sleeve 16, and the field line angle α is again detected by the sensor device 42 through the Hall voltage as a result of the varying magnetic flux.

Not shown in the Figures is an embodiment in which the sensor device 42 includes a magnetically soft material that is arranged next to the magnet 46 on the side opposite from the Hall sensor 44 or under the magnet 46 on the side thereof facing the shifting sleeve 16 or the movable part 15.

By providing such a magnetically soft material which is associated with the magnet 46, the magnetic flux of the magnet 46 can be guided and thus the magnetic field M can be strengthened, as a result of which undesirable changes in the Hall effect due to the magnetic field of the drive coil 30 can be prevented or minimized. In addition, there are greater changes in the field line angle α when a stronger magnetic field M is provided.

The magnetically soft material may be ferromagnetic metals or metal oxides, for example.

Also not shown in the Figures is an embodiment of the positive engagement clutch 10 in which two sensor devices 42 are provided.

The configuration of the sensor device 42 and the determination of the position of the shifting sleeve 16 do not change here.

In the embodiment of the positive engagement clutch 10 with two sensor devices 42, the sensor devices 42 are arranged offset from each other in the circumferential direction, although the two sensor devices 42 are for example not offset from each other by 180 degrees.

By determining the engagement position of the shifting sleeve 16 using at least two sensor devices 42, it is also possible to detect, in addition to the current engagement position, whether the shifting sleeve 16 is slightly tilted.

If this is the case, the controller 56 can output an appropriate control command that will reorient the shifting sleeve 16 perpendicular to the first shaft 12.

FIG. 9 shows a further embodiment of the sensor device 42, which can also be used to determine the engagement position of the shifting sleeve 16.

The sensor device 42 shown here comprises two magnets 46, which each have a magnetic axis B and are arranged obliquely with respect to the central axis A of the Hall sensor 44. Here, the magnetic axes B are directed toward each other and arranged at an acute angle relative to the central axis A.

For example, the two magnets 46 are oriented unsymmetrically in relation to each other with respect to the central axis A, with the angle between the magnetic axes B and the central axis A each being less than 45 degrees.

Such an arrangement of the magnets 46 allows as strong a magnetic field M as possible to be generated, so that changes in the magnetic field M lead to a major field line change. Accordingly, the signal detected by the Hall sensor 44 can be amplified so that a higher resolution can be achieved.

According to a further embodiment, not shown, the sensor device 42 comprises at least two Hall sensors 44, each of the Hall sensors 44 having a magnet 46 associated with it. By using two Hall sensors 44, the field line angles can be measured at several points, so that a more accurate result and thus a more precise determination of the position of the shifting sleeve 16 can be achieved.

In an alternative embodiment, the sensor device 42 also comprises at least two Hall sensors 44, although in this case the Hall sensors 44 do not each have a magnet 46 of their own associated with them.

While a positive engagement clutch 10 having one clutch body 20 has been described in the Figures, the sensor device 42 may also be installed in a two-sided positive engagement clutch 10.

Alternatively, the positive engagement clutch 10 may comprise two sensor devices 42, each of which is associated with one side of the shifting sleeve 16.

The positive engagement clutch 10 illustrated distinguishes itself in that no add-on parts need to be attached to the shifting sleeve 16 to be able to detect the position of the shifting sleeve 16.

1. An electromagnetically shiftable positive engagement clutch, comprising
an axially movable, driven part which is arranged on a shaft for joint rotation therewith and is linearly displaceable along the shaft between a clutch engagement position and a clutch disengagement position;
at least one axially fixed part to be driven, which is aligned coaxially with the shaft;
a stator having at least one energizable drive coil configured for adjustment of the movable part along the shaft,
wherein in the clutch engagement position there is a positive engagement between the movable part and the fixed part and thus a rotary connection between the shaft and the fixed part, and
a stationary sensor device which is arranged adjacent to the movable part and comprises at least one Hall sensor and at least one magnet that is arranged next to and permanently stationary relative to the at least one Hall sensor,
wherein the sensor device is arranged in an axial or radial direction so as to be spaced apart from the movable part by a gap, and the Hall sensor is configured such that it can detect a displacement of the movable part through a change in a field line angle of a magnetic field generated by the magnet.

2. The electromagnetically shiftable positive engagement clutch according to claim 1, wherein the Hall sensor has an evaluation unit integrated therein, the evaluation unit being configured to determine the field line angle of the magnetic field generated by the magnet and to pass it on to a controller of the electromagnetically shiftable positive engagement clutch.

3. The electromagnetically shiftable positive engagement clutch according to claim 1, wherein the Hall sensor comprises two measuring points.

4. The electromagnetically shiftable positive engagement clutch according to claim 3, wherein the field line angle corresponds to a mean value of the two measuring points.

5. The electromagnetically shiftable positive engagement clutch according to claim 1, wherein the sensor device comprises two magnets, the Hall sensor being arranged between the two magnets.

6. The electromagnetically shiftable positive engagement clutch according to claim 5, wherein the two magnets each have a magnetic axis and are arranged obliquely with respect to a central axis of the Hall sensor, wherein the magnetic axes are directed toward each other and are arranged at an acute angle relative to the central axis.

7. The electromagnetically shiftable positive engagement clutch according to claim 6, wherein the magnetic axes are directed toward each other and are arranged at an angle of less than 45 degrees relative to the central axis.

8. The electromagnetically shiftable positive engagement clutch according to claim 1, wherein the magnets are permanent magnets or electromagnets.

9. The electromagnetically shiftable positive engagement clutch according to claim 1, wherein the sensor device comprises at least two Hall sensors.

10. The electromagnetically shiftable positive engagement clutch according to claim 9, wherein each of the Hall sensors has at least one magnet associated with it.

11. The electromagnetically shiftable positive engagement clutch according to claim 1, wherein the sensor device is received in a sensor housing, the sensor housing being mounted to a stator housing.

12. The electromagnetically shiftable positive engagement clutch according to claim 1, wherein at least two sensor devices are provided, the at least two sensor devices being arranged offset from each other in the circumferential direction of the stator.

13. The electromagnetically shiftable positive engagement clutch according to claim 1, wherein the magnet has a magnetically soft material associated with it, the magnetically soft material being arranged next to the magnet on the side opposite from the Hall sensor or under the magnet on the side thereof facing the movable part.

14. A method of determining a position of a movable part of an electromagnetically shiftable positive engagement clutch according to claim 1, comprising the steps of:
detecting a Hall voltage using a Hall sensor;
calculating a field line angle by using an evaluation unit integrated in the Hall sensor;
passing the field line angle on to a controller of the electromagnetically shiftable positive engagement clutch; and
assigning, by the controller, a unique position of the movable part based on the calculated field line angle.

15. The method according to claim 14, wherein the position of the movable part is determined by a plurality of Hall sensors, wherein the positions determined are compared with each other by the controller.

16. The method according to claim 15, wherein the Hall sensors are offset from each other along the circumference of a stator.

17. The method according to claim 15, wherein the field line angle is determined for each position of the movable part of the electromagnetically shiftable positive engagement clutch.
